(19) United States
(12) Patent Application Publication
(10) Pub. No.: US 2023/0097974 A1
(43) Pub. Date: Mar. 30, 2023

(54) METHOD FOR ASSEMBLING AT LEAST ONE RING COOPERATING BY SHRINKING WITH A SHRINK-FITTING SURFACE OF A PART

(71) Applicant: NTN-SNR ROULEMENTS, Annecy (FR)

(72) Inventors: Guy AZAM, Drumettaz-Clarafond (FR); Yvan CAPELLI, Annecy (FR); Gilles FORRAT, Annecy (FR); Julien GRANGIER, Annecy (FR); Eric THEAU, Annecy (FR)

(73) Assignee: NTN-SNR ROULEMENTS, Annecy (FR)

(21) Appl. No.: 17/930,756

(22) Filed: Sep. 9, 2022

(30) Foreign Application Priority Data
Sep. 10, 2021 (FR) 2109513

(51) Int. Cl. B60B 27/00

(52) U.S. Cl. CPC B60B 27/0078; B60B 27/0026; B60B 2310/314; B60B 2310/316

(57) ABSTRACT

A method for assembling a ring by shrinking the ring onto a shrink-fitting surface of a part, the shrink-fitting surface being turned radially away from a reference axis, the part having a free upper end and an inner wall extending around the reference axis turned radially toward the reference axis and extending axially while delimiting at least part of an axial cavity. The method including the steps of forming, on the inner wall, splines extending axially; shrinking the ring on the part so that a lower transverse face of the ring comes into abutment against a shoulder of the part. After the step of forming the splines and prior to the step of shrinking the ring onto the part, radial elastoplastic expansion of an upper portion of the part results in a widening of the shrink-fitting surface and of a portion of the splines.

### CROSS REFERENCE TO RELATED APPLICATIONS

This application claims priority from French Patent Application No. 2109513, filed Sep. 10, 2021, the disclosure of which is incorporated herein by reference in its entirety.

### TECHNICAL FIELD

The invention relates, in general, to the technical field of the assembly of mechanical parts.

The invention relates more specifically to the assembly of a part such as a driving wheel hub of a vehicle on a transmission bowl.

### BACKGROUND

Generally, the rotation of a hub or a vehicle wheel spindle is done by means of a bearing. Most of the time, this bearing comprises an outer ring, two rows of rolling bodies and at least one inner ring fitted onto the hub in such a way that this inner ring comes into axial abutment against a shoulder of a bearing surface of the hub.

The rolling bodies of a row roll on one of the raceways of the outer ring and the raceway of the inner ring. Those of the other row roll on the other raceway of the outer ring and the raceway of the hub or a second inner ring. The so-called inner ring(s) is (are) fitted onto the hub.

Whatever the configuration, the inner ring(s) is (are) immobilized radially by fitting onto the hub. Furthermore, the bearing is immobilized axially in one direction by its bearing against the shoulder of the hub and axially in the other direction by an annular flange formed by plastic deformation of a part of the hub on which the inner ring to be maintained is mounted, or possibly by the transmission bowl. This flange, or this transmission bowl, has a retention face applied under pressure to the upper face of the ring, so as to immobilize the ring axially, in axial thrust against the shoulder of a bearing surface of the hub. Once the flange has been formed, or the transmission has been tightened, the assembly is ready for use, since the axial retention of the inner ring(s) is ensured by the flange or the transmission bowl.

The wheel hub consists of a part defining a geometric axis of rotation and having an axial cavity provided with splines on an inner wall for torque transmission purposes. Indeed, these splines allow coupling with the transmission bowl and thus ensure the function of passing the torque to the wheels.

The axial cavity of the hub is open at one end where the inner ring retention device is located, this same opening being configured to allow the entry of a splined axis of the transmission bowl cooperating with the internal splines of the axial cavity of the hub when the transmission bowl is assembled with the hub.

A broaching operation to obtain the splines can be performed on the hub alone, before assembly of the bearing. This is the case for example in the solution described in patent US 7,707,724 B2. In this case, however, assembling the bearing after the splines have been produced has the effect of shrinking the splines and deteriorating the geometric precision, in particular the straightness, of these splines. This is true even when a constraining operation of the shrink-fitted zone is carried out during the broaching operation.

A possible solution to overcome this problem could consist in performing broaching after final assembly of the bearing, but this operation is restrictive in terms of the manufacturing method, since it requires using a broaching means at one stage of the manufacturing program which would cause substantial additional costs.

### SUMMARY

The invention aims to remedy all or part of the drawbacks of the art by proposing a method of manufacturing an assembly of at least one bearing ring on a driving wheel hub making it possible to limit any deterioration of the straightness of the splines after forming, thus guaranteeing perfect transmission of the torque between the transmission bowl and the wheel hub, and ensuring easy assembly of these two components together.

To do this, according to a first aspect of the invention, proposed is a method for assembling at least one ring cooperating by shrinking with a shrink-fitting surface of a part defining a reference axis and having a through axial cavity, the shrink-fitting surface being turned radially away from the reference axis, the part having a free upper end and an inner wall extending around the reference axis turned radially toward the reference axis and extending axially while delimiting at least part of the axial cavity, preferably so as to present at least partial axial overlap with the shrink-fitting surface, the assembly method comprising:
a step of forming, on the inner wall, splines extending axially;
a step for shrinking the ring on the shrink-fitting surface of the part so that a lower transverse face of the ring comes into abutment against a shoulder of the part;
the assembly method being remarkable in that it comprises, after the step of forming the splines and prior to the step of shrinking the ring onto the shrink-fitting surface of the part, a step of radial elastoplastic expansion of an upper portion of the part, which results in a widening of the shrink-fitting surface and of a portion of the splines, followed if necessary by a step of machining the shrink-fitting surface, the subsequent shrinking of the ring on the shrink-fitting surface causing a deformation of the upper portion such that said portion of the splines approaches the reference axis.

An “elastoplastic” expansion is understood to mean an expansion that evolves first as an elastic deformation and then as a second plastic deformation. In this way, once the radial elastoplastic expansion of the upper portion of the part has been carried out, the part does not return to its initial shape and retains a widening of both the shrink-fitting surface and the portion of the splines.

Such a method makes it possible to carry out the step of radial expansion independently of the operation for producing the splines: this has the direct advantage of being able to carry out this method independently of other steps that can be implemented possibly by other devices or in different places.

Another advantage provided by such a method is the possibility of more faithfully adapting the need to anticipate the shrinkage by adjusting the necessary elastoplastic deformation based on the type of bearing, whatever the axial holding device of the inner ring(s) on the part. This deformation adjustment can be predetermined in particular from successive tests and can take into account the effects of the various subsequent stages that will have an impact on the deformation of the upper portion

According to one embodiment, the portion of the splines comprises, or even consists of, a portion in at least partial axial overlap with the shrink-fitting surface.

According to one embodiment, the part is in one piece.

According to one embodiment, the part is metallic, preferably formed based on steel, preferably again made of steel. Such a material is chosen for its structural characteristics as well as for its elastoplastic behavior.

According to one embodiment, the radial elastoplastic expansion of the upper portion of the part deforms at least one cylindrical portion of the axial cavity having a nominal diameter taken before expansion into a flared portion whereof a smaller diameter taken after expansion on the same cylindrical portion is greater than or equal to the nominal diameter of said cylindrical portion taken before expansion. This results in a radial expansion of the portion of the associated axial cavity that evolves progressively along the reference axis. This flare is oriented in the direction of greater expansion toward the axial free upper end of the upper portion designed to accommodate the transmission.

According to one embodiment, during the step of radial elastoplastic expansion of the upper portion of the part, a continuous control of the expansion is carried out, the step of radial elastoplastic expansion of the upper portion of the part preferably being controlled according to the data of the continuous control carried out. In this way, the elastoplastic expansion stage is effectively controlled.

According to one embodiment, the radial elastoplastic expansion of the upper portion of the part is located axially between the shoulder of the bearing surface of the part and the free upper end.

According to one embodiment, the axial cavity has at least one change in internal diameter located axially between the shoulder of the cylindrical bearing surface of the part and the free upper end, and oriented in the direction of a reduction in thickness of the cylindrical bearing surface directed toward the free upper end.

According to one embodiment, the radial elastoplastic expansion step comprises using a radial expansion tool, in particular for converting axial displacement into radial expansion displacement, preferably a step for placing a plurality of expansion segments through the free upper end and distributed around an expansion cone, and a step of applying an axial force to the expansion cone. Of course, other elastoplastic expansion methods can be used, for example: by direct bearing (axial force) of a shaped expansion tool (for example cone) on the area to be flared; by introducing a tool implementing a pressurized fluid to carry out the expansion of an expansion tool; or by any other method to ensure the targeted deformation.

According to one embodiment, the step of forming open splines on the inner wall is a broaching step.

According to one embodiment, the inner wall is an inner wall of revolution.

According to one embodiment, the assembly method comprises, after the step of shrinking the ring, a step of forming an annular flange from the free upper end of the part, the annular flange having a retention face applied to the upper transverse face of the ring, so as to immobilize the ring axially, in axial support against the shoulder of the bearing surface of the part. Of course, other alternative or complementary assembly modes of the ring are possible. For example, a screwed transmission can be provided that would bear against the ring instead of the annular flange.

According to one embodiment, the step of forming the annular flange results in a local deformation of the upper portion such that the portion of the splines, for example overlapping with the shrink-fitting surface, approaches the reference axis. In such a configuration, the step of radial elastoplastic expansion of the upper portion of the part is configured so as to take into account this step of deformation of the upper portion in addition to the step of subsequent shrinking of the ring on the shrink-fitting surface so that, once the assembly method is completed, the splines are as straight as possible despite the deformations undergone through the various stages of the implemented assembly method.

According to one embodiment, the step of forming the annular flange comprises a crimping step, preferably an orbital crimping step. This orbital crimping step is also sometimes referred to as “heading.” In this case, the step of shrinking the ring on the shrink-fitting surface of the part is configured so that the lower transverse face of the ring abuts against a shoulder of the part, but also so that the free upper end of the part protrudes axially from an upper transverse face of the ring. The annular flange can thus be formed from this part protruding from the free upper end of the part.

According to one embodiment, the step of radial elastoplastic expansion of the upper portion of the part is configured so as to obtain a predetermined flare both of the shrink-fitting surface and of the portion of the splines, for example overlapping with the shrink-fitting surface. This widening is predetermined according to the subsequent steps tending to locally deform the upper portion such as the portion of the splines, for example overlapping with the shrink-fitting surface, in the direction approaching the reference axis, and in order to obtain an assembly whose splines are as rectilinear as possible.

According to one embodiment, the ring is an inner ring of a bearing and the part is a hub, preferably a driving wheel hub.

The invention also relates to a part, in particular a motor vehicle driving wheel hub, intended to be assembled with at least one ring according to the assembly method as described above, the part comprising a shrink-fitting surface defining a reference axis and having a through axial cavity, the shrink-fitting surface being configured to receive at least one shrink-fit ring and being turned radially away from the reference axis, the part having a free upper end and an inner wall extending around the reference axis facing radially toward the reference axis and extending axially while delimiting at least part of the axial cavity, the part comprising splines extending axially on the inner wall, the part being remarkable in that it comprises an upper portion expanded radially and in an elastoplastic manner, provided with a widening of the shrink-fitting surface and the portion of the splines.

The invention also relates to an assembly, such as a kit, comprising a part as described above, in particular a motor vehicle driving wheel hub, and at least one ring configured to cooperate by shrinking with a shrink-fitting surface of the part, the assembly being remarkable in that it is configured so that in an assembled position, the ring is shrunk on the shrink-fitting surface of the part so that a lower transverse face of the ring comes into abutment against a shoulder of the part, the shrinking of the ring on the shrink-fitting surface causing a deformation of the upper portion such that the portion of the splines approaches the reference axis.

According to another aspect of the invention, the latter relates to an assembly of a part and a ring shrunk on a shrink-fitting surface of the part, the assembly being characterized in that it is obtained directly by the method as described above.

### BRIEF DESCRIPTION OF THE FIGURES

Other features and advantages of the invention will emerge on reading the following disclosure, with reference to the appended figures, which illustrate:

FIG. 1: a sectional view of a driving wheel hub according to one embodiment, before a broaching step;

FIG. 2: a cross-sectional view of the hub of FIG. 1, during a broaching step;

FIG. 3: a cross-sectional view of the hub of FIG. 2, after the step of making the splines;

FIG. 4: a cross-sectional view of the hub of FIG. 3, provided with a shrink-fitted inner bearing ring;

FIG. 5: a sectional view of the hub of FIG. 4 after a crimping step;

FIG. 6A: a sectional view of a splined portion of the hub of FIG. 5;

FIG. 6B: a view of a graph illustrating curves of the dimensional impacts of the broaching, shrinking and crimping on the splined portion of the hub if no radial elastoplastic expansion step is implemented during the assembly method;

FIG. 7: a sectional view of the hub of FIG. 3 equipped with an expansion tool;

FIG. 8: an isometric view of FIG. 7;

FIG. 9: a sectional view of the hub of FIGS. 7 or 8 during a stage of radial expansion of the hub;

FIG. 10: a sectional view of the expanded hub after the step of radially expanding the hub of FIG. 9;

FIG. 11A: a sectional view of a splined portion of the hub of FIG. 5;

FIG. 11B: a view of a graph illustrating curves of the dimensional impacts of the broaching, shrinking and crimping on the splined portion of the hub, if a radial elastoplastic expansion step is implemented during the assembly method, before the steps of shrinking and crimping.

For greater clarity, identical or similar elements are identified by identical reference signs in all of the figures.

### DETAILED DESCRIPTION

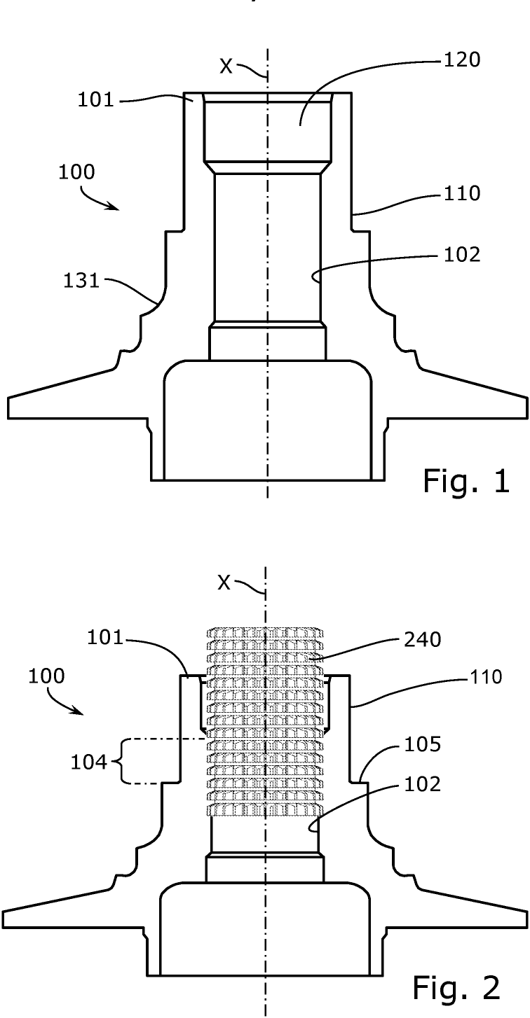

FIGS. 1 to 5 illustrate a longitudinal sectional view of a part 100 forming the hub of a driving wheel of a motor vehicle during different stages of a method of assembling a ring 10 on this hub 100, the ring being an inner ring 10 of a bearing.

In these figures, like the other figures, only the inner ring 10 of the bearing is illustrated. In general, the assembly 1 of the inner ring 10 and the hub 100 belongs to a rotating assembly intended to be guided in rotation about a geometric axis of rotation X with respect to a suspension member (not shown) using the bearing.

Such a bearing generally consists in the example of an outer ring with two outer raceways, a first inner raceway 131 directly formed on the component part of the hub 100, and a second inner raceway 132 formed on the inner ring 10 of the bearing fitted onto a cylindrical bearing surface 110 of the hub 100, rolling bodies (not shown) in two rows, for example balls, being interposed between the raceways. The outer ring generally comprises a fixing flange provided with an interface for fixing to the suspension member, for example comprising holes for inserting screws for fixing to the suspension member.

The part 100 defines a reference axis X and has a through axial cavity 120. The shrink-fitting surface 110, here cylindrical, on which the ring 10 is shrunk is turned radially away from the reference axis X. An inner wall 102 radially opposite the shrink-fitting surface 110 is turned radially toward the reference axis X and extends around the reference axis X and axially along this axis X so as to present an at least partial axial overlap with the shrink-fitting surface 110.

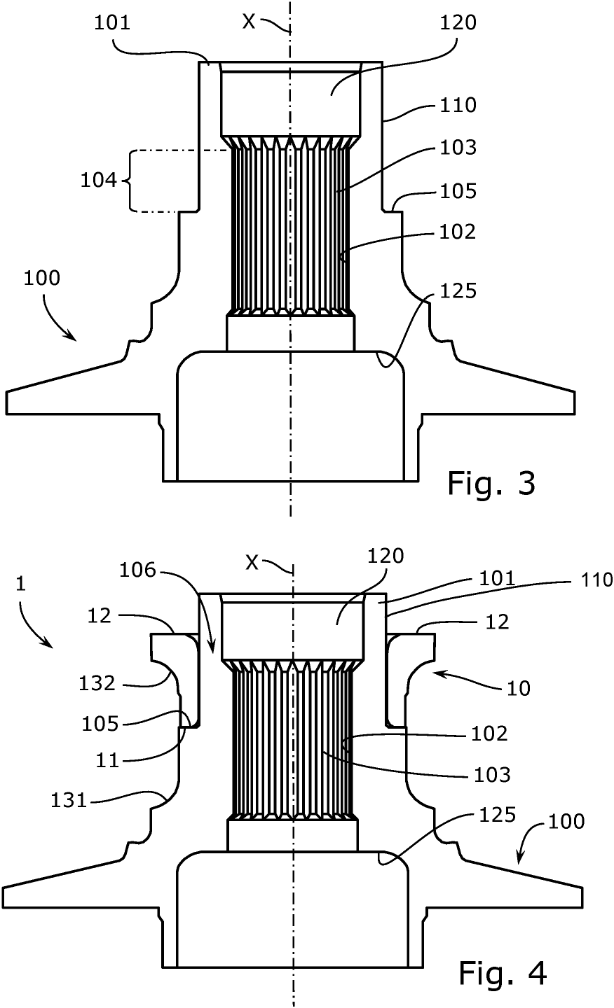

The hub 100 is intended to be driven in rotation by a transmission kinematic chain output member, constituted in particular by a transmission seal bowl (not shown), which can be homokinetic or quasi-homokinetic. The part constituting the bowl is provided with a splined shaft section intended to be inserted into the axial cavity 120 of conjugate shape made in the hub 100, in particular in the splines 103 extending axially on the inner wall 102 of the axial cavity 120 (see FIG. 3).

As illustrated in FIG. 2 , a step of forming axial splines 103 on the inner wall 102 is performed. In particular here, the step of forming splines 103 open on the inner wall 102 of revolution is a broaching step. During this operation, a splined broaching tool 240 is forcibly inserted into the axial cavity 120, contributing to machining by broaching the latter. The chips generated by the forced penetration of the broaching tool 240 into the cavity 120 are evacuated without difficulty through a wide opening at a lower end of the cavity 120, axially opposite a free upper end 101 defining an opening that is open axially and allows access to the broaching tool 240. The notion of “lower” or “upper” end of the part 101 does not refer to the final position of the assembly, but to the orientation of the part during the preferential assembly method described here. Of course, the assembly method can be implemented according to another orientation without distorting the invention, these “lower” or “upper” characteristics making it possible to distinguish the two ends from each other and having been chosen according to the orientation adopted in the figures. Likewise, the concept of a so-called “free” upper end is given before assembly, even if it has to be machined a posteriori, for example to undergo a crimping step and thus to form a flange as described below.

The broaching tool 240 comprises a pin, for example steel, provided with a series of teeth whose section corresponds to the profile to be executed. The length of the broach is defined by the number of teeth, which in turn is defined by the quantity of material to be removed. In general, each tooth removes a thickness of metal varying from 0.03 to 0.01 mm according to its shape and precise section.

The hub 100 is configured so that the splines 103 have a portion 104, which here is in at least partial axial overlap with the shrink-fitting surface 110 (see FIG. 3). Once the splines 103 have been made, the hub 100 therefore comprises a portion 104 extending axially, along which a corresponding portion of the splines 103 is superposed radially with a corresponding portion of the shrink-fitting surface 110.

FIG. 4 illustrates a step for shrinking the ring 10 on the shrink-fitting surface 110 of the part 100 so that a lower transverse face 11 of the ring 10 comes into abutment against a shoulder 105 of the part 100. Once the shrinking of the inner ring 10 of the bearing has been carried out, the upper free end 101 of the part 100 here projects axially with respect to an upper transverse face 12 of the ring 10, the upper transverse face 12 being axially opposite the lower transverse face 11 with respect to the ring 10.

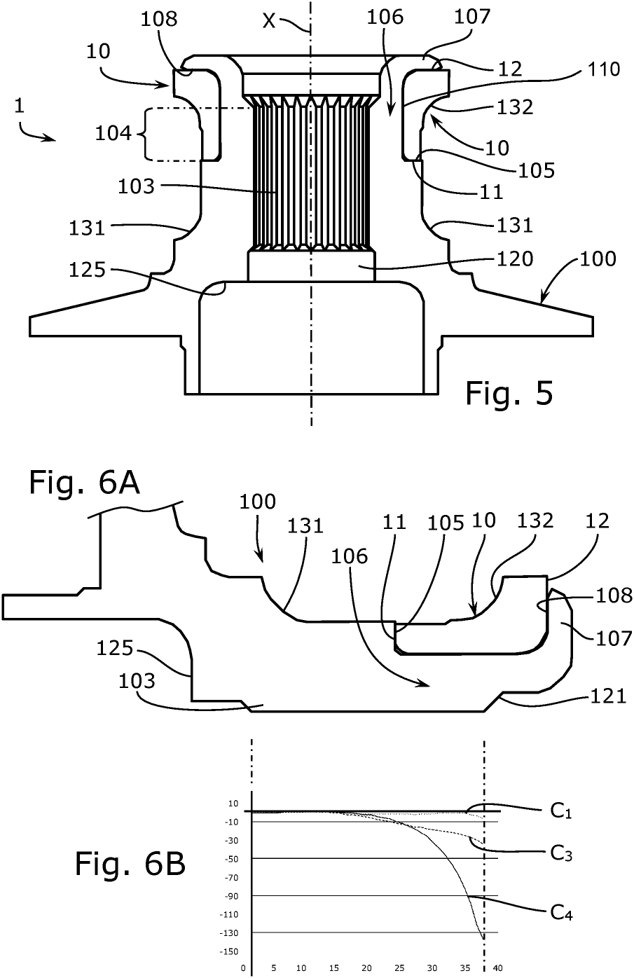

In FIG. 5, it is observed that an upper axial annular end 101 of the hub 100 has been folded radially outwards and preferably axially toward the inner ring 10 after fitting, in particular after shrinking, of the inner ring 10. This FIG. 5 illustrates the assembly 1 resulting from a step subsequent to the step of shrinking the ring 10, namely a step of forming an annular flange 107 from the free upper end 101 of the part 100. The annular flange 107 thus formed has a retention face 108 applied to the upper transverse face 12 of the ring 10, so as to immobilize the ring 10 axially, in axial bearing against the shoulder 105 of the bearing surface 110 of the part 100 on one side and bearing against the flange 107 on the other side axially.

This step of forming the annular flange 107 is carried out by material deformation, preferably using a rivet, if necessary after local heating of the part thus deformed forming the flange 107. Here this is in particular a crimping step, in particular orbital crimping.

The operation of shrinking the ring 10 on the shrink-fitting surface 110 of the part 100, like that of orbital crimping to form the flange 107, have in common that they have the effect of each generating a deformation of the upper portion 106, in particular comprising the portion 104 of the splines 103 here overlapping with the shrink-fitting surface 110, this deformation being oriented in the direction bringing the upper portion 106 closer to the reference axis X. In other words, the shrinking operation of the ring 10 causes shrinkage of the upper portion 106. In case of orbital crimping, this operation generally increases this shrinkage. This consequence is particularly visible in FIG. 6B, which illustrates a graph that shows curves of the dimensional impacts of the steps of broaching C1, shrinking C3 and orbital crimping C4 taken successively on the splined portion 103 of the hub 100, these curves being presented in perspective with FIG. 6A, which illustrates a more detailed sectional view of the splined portion 103 of the hub 100. The graph has as abscissa an axial position datum of the splined portion 103 of the hub 100 in millimeters and on the ordinate the measurement of the diameter deviation in microns.

The assembly 1 obtained is designed to receive a splined shaft section of the transmission seal bowl in the axial cavity 120. This cooperation of this splined shaft in the corresponding splined axial cavity makes it possible to oppose a relative rotation of the two parts and thus allow the transmission of torque during use of the vehicle.

In addition, the hub 100 is configured to also participate in the axial locking of the bowl. The axial cavity 120 is in particular dimensioned to be passed through by a component part of the bowl provided with a threaded or tapped end to accommodate a tapped or threaded body of a screw or a nut, the screw having a head coming to be pressed against a washer that bears against an annular surface 125 of the hub 100, forming a circular crown surrounding the axial cavity 120 at its lower end. On the axially opposite side of the axial cavity 120, an annular face of the bowl bears against a corresponding face of the hub 100 formed by the flange 107.

According to the invention, after the step of forming the splines 103 and prior to the step of shrinking the ring 10 onto the shrink-fitting surface 110 of the part 100, a step of radial elastoplastic expansion of an upper portion 106 of the part 100 is carried out.

Such an operation makes it possible to create a widening of the upper portion 106 of the hub 100, and in particular of both the shrink-fitting surface 110 and the portion 104 of the splines 103, in particular overlapping with the shrink-fitting surface 110.

The maximum resultant radial expansion is located at the free upper end 101. In this example, the maximum radial expansion measured in line with the upper end 101 can reach, or even exceed, 200 microns. The necessary radial expansion is predetermined and linked to the deformation observed during the broaching and shrinking steps.

This elastoplastic expansion step is followed by a step of machining, or even of rectification of the shrink-fitting surface 110 prior to the shrinking step. The subsequent shrinking of the ring 10 on the shrink-fitting surface 110 participates, at least in part, in causing a deformation of the upper portion 106 such that the portion 104 of the splines 103 here overlapping with the shrink-fitting surface 110 approaches the reference axis X. When no crimping step is then provided, then the shrinking step can constitute the only step of deformation approaching the reference axis X. However, when a crimping step is also provided after the shrinking of the ring 10, the radial elastoplastic expansion step is configured so as to take into account the deformation approaching the reference axis X provided later by this step of forming the flange 107.

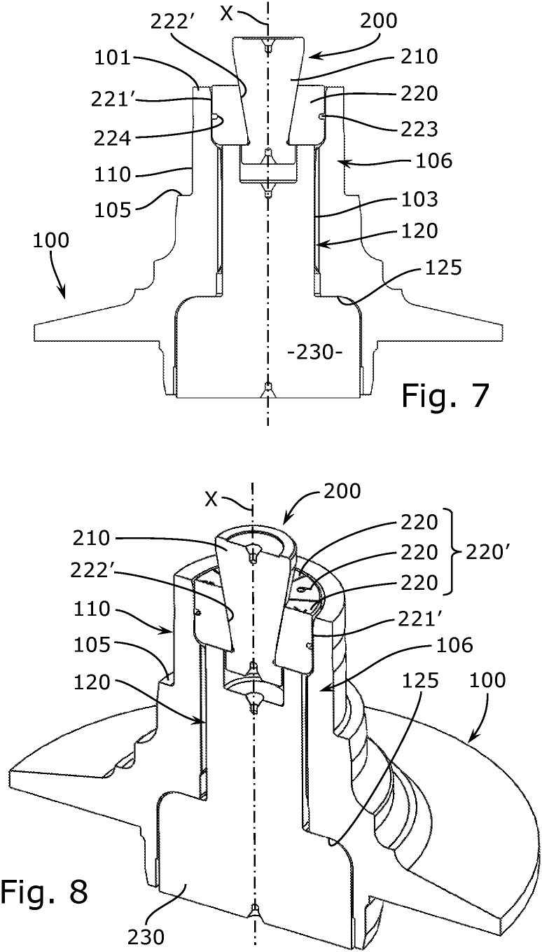

FIG. 7 and FIG. 8 both illustrate sectional views, one of which is in isometric perspective, of the hub 100 during such a radial elastoplastic expansion step of the upper portion 106 of the part 100 by means of an expansion tool 200. This expansion tool 200 is configured to convert axial displacement into radial displacement. The expansion tool 200 is composed in particular of a support 230 for a plurality of expansion segments 220 through the free upper end 101 and distributed around an expansion cone 210 owing to which it is possible to apply an axial force on the expansion cone 210, which in turn applies a force on the expansion segments 220. The set of expansion segments 220 is configured so as to form an annular assembly comprising the expansion segments 220 distributed around the expansion cone 210.

The upper portion 106 of the part 100 has a cylindrical inner contact surface carried by the axial cavity 120 coaxial with the reference axis X and oriented on the side of the reference axis X. This inner radial contact surface is located axially between an upper end of the splines 103 of the splined portion and the free upper end 101. The axial transition between the upper end of the splines 103 of the splined portion and the inner contact surface is marked by a change in internal diameter 121 extending in a generally annular, discontinuous or continuous manner. This internal diameter change 121 is also located axially between the shoulder 105 of the cylindrical bearing surface 110 of the part 100 and the free upper end 101, the internal diameter change 121 being oriented in the direction of a reduction in thickness of the wall of the hub 100 directed toward the free upper end 101.

The support 230 is in turn placed through the axial cavity of the hub by a lower part of the hub 100, axially opposite the upper portion 106. A radially enlarged base of this support 230 is dimensioned so as to come into axial abutment against the annular surface 125 of the hub 100 in the expanded position. The support 230 also comprises a shaft for insertion into the axial cavity 120. An upper portion of this shaft has an abutment interface making it possible to provide an end-of-travel abutment for axial travel of the expansion segments 220 distributed around the expansion cone 210 during the expansion operation.

The support 230 has a recess open axially at its distal end on the side of the expansion cone 210. This axial recess makes it possible to guarantee the axial travel of the expansion cone 210.

To implement the radial elastoplastic expansion operation of the upper portion 106 of the part 100, the support 230 is inserted into the axial cavity by the lower part of the hub 100 positioned vertically until it comes into abutment axially against the hub 100, in particular via its widened base, which bears against the annular surface 125 of the hub 100 of greater radial dimension than that of the axial cavity 120.

The expansion segments 220 are then placed in the upper portion 106 through the free upper end 101, each expansion segment 220 being positioned so as to be, on the one hand, radially into contact and bearing against a part of the cylindrical radial contact surface of the upper portion 106 carried by the axial cavity 120, and on the other hand, bearing axially against a bearing surface of the distal end of the support 230. The arranged expansion segments 220 form an annular assembly 220' in which a segment 220 taken alone corresponds to a portion of this annular assembly over a predetermined angular sector. This annular assembly 220' has an outer radial surface 221' formed by the circumferential series of the individual outer surfaces of the segments 220 and a radially inner surface 222' delimiting a space to accommodate the expansion cone 210. This inner surface extends so as to form a surface of revolution around the frustoconical reference axis X in the direction of a reduction in its diameter toward the inside of the axial cavity 120, this inner surface being formed by the generally continuous circumferential series of individual inner surfaces of segments 220 along an associated angular sector.

In this method in particular, at least in this radial expansion operation, the hub 100 is preferably oriented so that its reference axis X is placed vertically, the upper portion 106 of the part 100 being raised vertically upwards. Such a configuration facilitates and simplifies the implementation of the method by limiting the tools used and by skillfully using the forces of gravity to ensure the stability, in particular of the part 100 and of the support 230.

As visible in FIG. 7 and FIG. 8, at least one spring 223 is arranged annularly so as to radially surround all of the segments 220. At least one circular groove 224 may be provided for this purpose by surrounding the outer radial surface 221' carried by the set of segments 220. Such a spring 223 aims to maintain a unit of the set of segments 220 by constraining them radially inwards, i.e. toward the reference axis X in the assembly position. This in particular facilitates the manipulation of the segments 220, in particular when they are placed in the upper portion 106 of the axial cavity 120 through the free upper end 101.

The expansion cone 210, which in reality has a generally frustoconical outer shape complementary to the shape delimited by the radially inner surface 222' of the annular assembly 220', is used to apply an axial force to the inner surface 222'. The sliding of the two frustoconical surfaces generates a force on the annular assembly 220' having an axial component and a radial component.

It will be noted that the installation of the expansion cone 210 and of the segments 220 can be concomitant, especially if the annular assembly 220' is, on the one hand, held radially in abutment against the expansion cone 210 owing to the annular spring surrounding the annular assembly 220', and on the other hand, held axially on the expansion cone 210 owing to the tapered shape in one direction and by a flange projecting annularly with respect to a small base of the expansion cone 210 in the other direction.

The axial component of the force is taken up by the support 230, against the planar bearing surface delimiting the distal end of the support 230 and contained in a plane orthogonal to the reference axis X. The planar bearing surface delimiting the distal end of the support 230 is generally located axially closer to the free upper end 101 than to the upper end of the splines 103 of the splined portion, and more generally to the change in diameter 121, so as to prevent, given the configuration of the expansion tool 200 and of the support 230, the segments 220 from coming into contact or interacting with the splines 103 of the splined portion. The axial resultant of the forces is therefore taken up by the support 230.

The open axial recess opening onto this planar bearing surface and centered both on the distal end of the support 230 and on the reference axis X makes it possible to guarantee a sufficient and necessary stroke of the expansion cone 210 without interfering with said planar bearing surface against which the segments 220 rest.

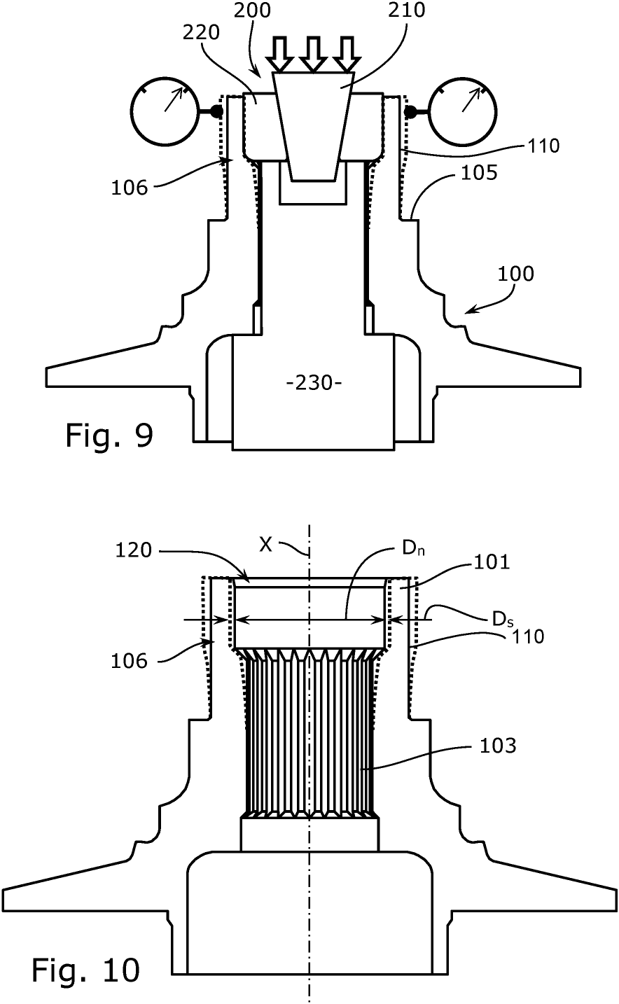

The radial component of the force is taken up for its part by the upper portion 106 carried by the axial cavity 120, which results, with a sufficient predetermined force, in a widening of the shrink-fitting surface 110 and of the portion 104 of the splines 103 at least overlapping with the shrink-fitting surface 110. This flare is illustrated in FIG. 9 and FIG. 10 by dotted lines of the associated upper portion 106 and is located axially overall between the shoulder 105 of the shrink-fitting surface 110 of the part 100 and the free upper end 101.

The radial elastoplastic expansion of the upper portion 106 of the part 100 deforms at least one cylindrical portion of the axial cavity 120 having a nominal diameter Dn taken before expansion into a flared portion whereof a smaller diameter Ds taken after expansion on the same cylindrical portion is greater than or equal to the nominal diameter Dn of said cylindrical portion taken before expansion.

The radial expansion is elastoplastic, that is to say, it evolves first as an elastic deformation, then second as a plastic deformation, while if necessary exhibiting an elastic return after relaxation of the expansion force, without, however, returning to its original position before expansion. In order not to damage the hub, this plastic deformation must be effectively controlled. As illustrated in FIG. 9, the control of the deformation is ensured by a continuous control of the expansion carried out during the radial expansion operation of the upper portion 106 of the part 100, the expansion operation preferably being controlled according to the data of the continuous control carried out, this control also preferably being continuous.

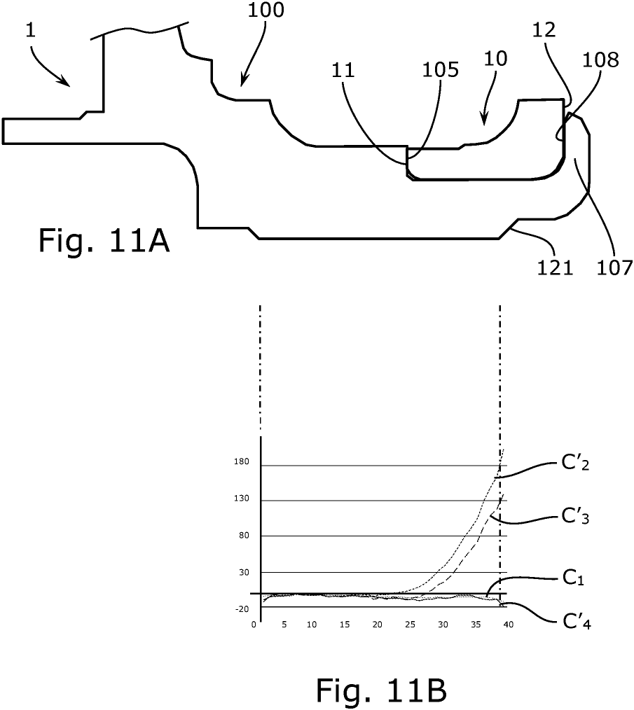

FIG. 11B illustrates a graph on which the curves are represented of the dimensional impacts of the steps of broaching C1, expansion C2', shrinking C3' then orbital crimping C4' on the splined portion 103 of the hub 100, these curves being shown in perspective with FIG. 11A, which illustrates a more detailed sectional view of the splined portion 103 of the hub 100.

After the broaching operation, the expansion operation is carried out tending to widen the upper portion 106. The following shrinking and crimping operations tend to deform the upper portion 106 in the direction of an approach toward the reference axis X, in particular the shrink-fitting surface 110, thus making it possible to guarantee on the one hand the proper attachment of the ring 10 to the shrink-fitting surface 110 as well as, on the other hand, a straightness of the splines 103 very close to the original splines, just after the broaching operation. A machining operation can be implemented between the expansion and shrinking operations to allow the assembly of the ring, in particular when the expansion results in a shrinking diameter greater than the internal diameter of the ring.

In particular, the graph shows the change in the straightness of the splines over the operations carried out: curve C1 illustrates the straightness of the splines 103 obtained after the broaching operation; curve C2' illustrates the straightness of the splines 103 after a subsequent elastoplastic expansion operation, curve C3' illustrates the straightness of the splines 103 after the successive operation of shrinking the inner ring 10, then finally curve C4' illustrates the final straightness of the splines 103 after the crimping operation.

This demonstrates obtaining a straightness close to the original value (less than 20 µm of defect) and thus the efficiency of the method. Indeed, the assembly method is configured so that the diameter deviation of the axial cavity 120 taken in line with the splines 103, on the one hand, before the step of radial elastoplastic expansion of the upper portion 106 and, on the other hand, once the assembly method with the ring 10 has been implemented, in a configuration where the assembly 1 is ready to be coupled with the transmission bowl (after shrinking of the ring 10, and if necessary crimping, for example), is less than 20 µm. Such a measurement is carried out for example using a ball feeler system.

At the time of shrinking the inner ring 10 on the hub 100, there is an assembly in the disassembled position in which, before said assembly of the ring 10 with the part 100, the part 100 comprises an upper portion 106 expanded radially and in an elastoplastic manner, provided with a flare and the shrink-fitting surface 110 and the portion of the splines 103 overlapping with the shrink-fitting surface 110.

In an assembled position, the ring 10 is shrunk on the shrink-fitting surface 110 of the part 100 so that a lower transverse face 11 of the ring comes into abutment against a shoulder 105 of the part 100 and the free upper end 101 of the part protrudes axially from an upper transverse face 12 of the ring 10 for the embodiment described here, the shrink-fitting surface 110 preferably being at least partly machined, depending on the subsequent operations, the shrinking at least of the ring 10 on the shrink-fitting surface 100 causing an elastic deformation of the upper portion 106 such that the portion 104 of the splines 103 at least overlapping with the shrink-fitting surface 110 approaches the reference axis X.

It is understood that the elastoplastic expansion and shrinking operations can be carried out easily on different geographical locations. Such an elastoplastic expansion step is therefore easy to implement and does not require the use of a means for producing splines on the same production site.

Of course, the invention is described in the above by way of example. It is understood that a skilled person is in a position to produce various variant embodiments of the invention without, however, departing from the scope of the invention.

For instance, the shrinking step can comprise shrinking several rings 10, for example two rings 10, on the shrink-fitting surface 110 of the part 100. In this case, the rings 10 are placed successively, coaxially with the reference axis X. It will be understood that only one of these rings 10, for example a first ring, will have a lower transverse face 11 that abuts against a shoulder 105 of the part 100. A second ring has a lower transverse face 11 that may or may not come into abutment against an upper face of the first of the rings 10.

It is emphasized that all the features, as they emerge for a person skilled in the art from the present description, the drawings and the attached claims, even if concretely they have only been described in relation to other determined features, both individually and in arbitrary combinations, may be combined with other features or groups of features disclosed here, provided that this has not been expressly excluded or that technical circumstances do not make such combinations impossible or devoid of meaning.

1. A method for assembling at least one ring cooperating by shrinking with a shrink-fitting surface of a part defining a reference axis and having a through axial cavity, the shrink-fitting surface being turned radially away from the reference axis, the part having a free upper end and an inner wall extending around the reference axis turned radially toward the reference axis and extending axially while delimiting at least part of the axial cavity, the assembly method comprising:
a step of forming, on the inner wall, splines extending axially;
a step for shrinking the ring on the shrink-fitting surface of the part so that a lower transverse face of the ring comes into abutment against a shoulder of the part;
the assembly method comprising, after the step of forming the splines and prior to the step of shrinking the ring onto the shrink-fitting surface of the part, a step of radial elastoplastic expansion of an upper portion of the part, which results in a widening of the shrink-fitting surface and of a portion of the splines, the subsequent shrinking of the ring on the shrink-fitting surface causing a deformation of the upper portion such that said portion of the splines approaches the reference axis.

2. The method according to claim 1, wherein the portion of the splines comprises a portion in at least partial axial overlap with the shrink-fitting surface.

3. The method according to claim 1, wherein the radial elastoplastic expansion of the upper portion of the part deforms at least one cylindrical portion of the axial cavity having a nominal diameter taken before expansion into a flared portion whereof a smaller diameter taken after expansion on the same cylindrical portion is greater than or equal to the nominal diameter of said cylindrical portion taken before expansion.

4. The method according to claim 1, wherein during the step of radial elastoplastic expansion of the upper portion of the part, a continuous control of the expansion is carried out, the step of radial elastoplastic expansion of the upper portion of the part preferably being controlled according to the data of the continuous control carried out.

5. The method according to claim 1, wherein the radial elastoplastic expansion of the upper portion of the part is located axially between the shoulder of the shrink-fitting surface of the part and the free upper end.

6. The method according to claim 1, wherein the axial cavity has at least one change in internal diameter located axially between the shoulder of the cylindrical bearing surface of the part and the free upper end, and is oriented in the direction of a reduction in thickness of the cylindrical bearing surface directed toward the free upper end.

7. The method according to claim 1, wherein the radial elastoplastic expansion step comprises using a radial expansion tool, for converting axial displacement into radial expansion displacement, and a step for placing a plurality of expansion segments through the free upper end and distributed around an expansion cone, and a step of applying an axial force to the expansion cone.

8. The method according to claim 1, wherein the step of forming splines open on the inner wall, is a broaching step.

9. The method according to claim 1, wherein the method comprises, after the step of shrinking the ring, a step of forming an annular flange from the free upper end of the part, the annular flange having a retention face applied to the upper transverse face of the ring, so as to immobilize the ring axially, in axial support against the shoulder of the bearing surface of the part.

10. The method according to claim 8, wherein the step of forming the annular flange results in a local deformation of the upper portion such that the portion of the splines overlapping with the shrink-fitting surface approaches the reference axis.

11. The method according to claim 8, wherein the step of forming the annular flange comprises a crimping step.

12. The method according to claim 1, wherein the ring is an inner ring of a bearing and the part is a hub.

13. A part, in particular a motor vehicle driving wheel hub, intended to be assembled with at least one ring, the part comprising a shrink-fitting surface defining a reference axis and having a through axial cavity, the shrink-fitting surface being configured to receive at least one shrink-fit ring and being turned radially away from the reference axis, the part having a free upper end and an inner wall extending around the reference axis facing radially toward the reference axis and extending axially while delimiting at least part of the axial cavity, the part comprising splines extending axially on the inner wall, the part being characterized in that it comprises an upper portion expanded radially and in an elastoplastic manner, provided with a widening of the shrink-fitting surface and the portion of the spline.

14. An assembly comprising a part according to claim 13, and at least one ring configured to cooperate by shrinking with a shrink-fitting surface of the part, the assembly being characterized in that it is configured so that in an assembled position, the ring is shrunk on the shrink-fitting surface of the part so that a lower transverse face of the ring comes into abutment against a shoulder of the part, the shrinking of the ring on the shrink-fitting surface causing a deformation of the upper portion such that the portion of the splines approaches the reference axis.

15. The assembly of a part and a ring shrunk on a shrink-fitting surface of the part, the assembly being characterized in that it is obtained by the method according to claim 1.

16. The method according to claim 11, wherein the step of forming the annular flange comprises a crimping step that is an orbital crimping step.

17. The method according to claim 12, wherein the ring is an inner ring of a bearing and the part is a driving wheel hub.
